(19) United States
(12) Patent Application Publication
(10) Pub. No.: US 2014/0307449 A1
(43) Pub. Date: Oct. 16, 2014

(54) Reflection Cap for Lamp

(71) Applicants: DUCK MUK LEE, (US); L&KANG, INC, LOS ANGELES, CA (US)

(72) Inventor: Duk Muk Lee, Yongin-si (KR)

(73) Assignees: L&KANG, INC, LOS ANGELES, CA (US); DUK MUK LEE, YONGIN-SI (KR)

(21) Appl. No.: 13/870,841

(22) Filed: Apr. 25, 2013

(30) Foreign Application Priority Data
Apr. 10, 2013 (KR) 10-2013-0039350

(51) Int. Cl. F21V 7/00

(52) U.S. Cl. CPC F21V 7/005
USPC 362/347

(57) ABSTRACT

The present invention relates to a reflection cap for a lamp including: a body open on both ends thereof and having a reflection plate disposed on the upper portion thereof and a transparent plate disposed on the lower portion thereof; left and right end caps detachably fixed to both ends of the body and each having a boss protrudedly formed on the outer surface thereof, the boss having a through-hole formed thereon in such a manner as to fittingly insert the fluorescent lamp thereinto; and a fluorescent lamp fixing member rotatably coupled to the boss and adapted to hold and rotate a fluorescent lamp finishing portion clockwisely or counter-clockwisely so as to connect connection terminals of the fluorescent lamp fitted to the through-hole to connection terminals of a socket.

### CROSS-REFERENCE TO RELATED APPLICATION

This application is based on and claims priority from Korean Patent Application No. 10-2013-0039350, filed on Apr. 10, 2013 in the Korean Intellectual Property Office, the disclosure of which is incorporated herein in its entirety by reference.

### BACKGROUND OF THE INVENTION

1. Field of the Invention

The present invention relates to a reflection cap for a lamp, and more particularly, to a reflection cap for a lamp that is capable of easily exchanging a fluorescent lamp.

2. Background of the Related Art

Korean Patent Application Laid-Open No. 10-2012-0061732 discloses a lamp reflection case including: a body having a pair of openings formed on both ends thereof in such a manner as to communicate to each other and a lamp housing space into which a lamp (which means a fluorescent lamp) is housed; a reflector formed on one surface of the interior of the body to reflect the light emitted from the lamp; and a support plate adapted to support the position of the lamp housed in the lamp housing space in such a manner as to allow the lamp to be inserted into the lamp housing space of the body and to be mounted on the body, wherein the body has a transparent plate having a shape of a plate having both long sides and both short sides and adapted to allow the light emitted from the lamp to be passed therethrough and a reflection plate located above the transparent plate in such a manner as to form the lamp housing space together with the transparent plate, the reflector is formed on the inner surface of the reflection plate, and the support plate is placed between the transparent plate and the reflection plate in such a manner as to allow the lamp housing space as the separated space between the transparent plate and the reflection plate to be maintained, while having through-holes into which both end portions of the lamp are inserted.

Further, the conventional lamp reflection case includes incised portions formed on the transparent plate so as to allow the left and right sides of the support plate having the through-holes into which the lamp is fitted to be foldable to fix the lamp to the body of the reflection case having a semicircular section.

After one end of the lamp is passed and moved through the through-hole of one side support plate, however, it is not easy to insertedly fit the other end of the lamp to the through-hole of the other side support plate. Accordingly, the exchanging time of the lamp is increased to make the reliability and practicability badly deteriorated.

Additionally, the irradiation angle of light emitted by the lamp is restricted by the size of width of the transparent plate having a flat surface, thereby undesirably having the limitations in the enhancement of illumination.

### SUMMARY OF THE INVENTION

Accordingly, the present invention has been made in view of the above-mentioned problems occurring in the prior art, and it is an object of the present invention to provide a reflection cap for a lamp that is capable of enlarging the irradiation angle of light emitted by a fluorescent lamp and enhancing the reflection rate of the light.

It is another object of the present invention to provide a reflection cap for a lamp that is capable of being simple in configuration to reduce the manufacturing cost, easily exchanging a fluorescent lamp, and reducing the assembling and installing time.

To accomplish the above objects, according to the present invention, there is provided a reflection cap for a lamp including: a body open on both ends thereof and having a reflection plate disposed on the upper portion thereof in such a manner as to reflect the light emitted by a fluorescent lamp housed therein and a transparent plate disposed on the lower portion thereof in such a manner as to be connected to both ends of the underside portion of the reflection plate and to transmit the light emitted by the fluorescent lamp therethrough; left and right end caps detachably fixed to both ends of the body and each having a boss protrudedly formed on the outer surface thereof, the boss having a through-hole formed thereon in such a manner as to fittingly insert the fluorescent lamp thereinto; and a fluorescent lamp fixing member rotatably coupled to the boss and adapted to hold and rotate a fluorescent lamp finishing portion clockwisely or counter-clockwisely so as to connect connection terminals of the fluorescent lamp fitted to the through-hole to connection terminals of a socket.

According to the present invention, desirably, the fluorescent lamp fixing member has a female screw portion formed along the inner periphery thereof, and the boss has a corresponding male screw portion to the female screw portion formed on the outer periphery thereof, so that the fluorescent lamp fixing member is detachably screw-coupled to the boss.

According to the present invention, desirably, the fluorescent lamp fixing member has a locking step formed on the inside bottom periphery thereof, through-holes formed radially on the lower periphery thereof in such a manner as to face each other, and a packing having a ring seated on the locking step and pressurizing portions protrudedly formed from the outer peripheral surface of the ring in such a manner as to be fitted to the through-holes, so that as the pressurizing portions are pressed in the radial direction of the fluorescent lamp fixing member, the fluorescent lamp fixing member holds the fluorescent lamp finishing portion.

According to the present invention, desirably, the packing is made of a silicone material or rubber material.

According to the present invention, desirably, each of the left and right end caps includes: a housing having a side plate having the boss disposed on the outer surface thereof and a support plate formed on the inner periphery thereof to a shape of a streamline in such a manner as to support the outer surfaces of the end portions of the reflection plate and the transparent plate of the body; and a streamline-shaped supporter fixed to the support plate in such a manner as to be spaced apart from the support plate to support the inner surfaces of the end portions of the reflection plate and the transparent plate of the body, so that each end portion of the body of the reflection cap is fixedly fitted to a streamline-shaped coupling slot formed by the support plate of the housing and the supporter.

According to the present invention, desirably, the body has a streamlined cross section.

According to the present invention, desirably, the reflection plate includes a reflection layer formed on the inner surface thereof to enhance the illumination of the fluorescent lamp, the reflection layer being formed of a layer of silver coated with silver or a silver reflection film.

According to the present invention, desirably, the transparent plate is made of any one of a PET material, PC material, acrylic material, and PMMA material.

According to the present invention, desirably, the supporter includes: a first slant surface formed on the upper portion of the outer peripheral surface thereof in such a manner as to guide the sliding of the body if each end of the body is fitted to the streamlined coupling slot; and a second slant surface formed on the lower portion of the outer peripheral surface thereof to a slower inclination degree than that of the first slant surface in such a manner as to compressingly support each end portion of the body fitted to the streamlined coupling slot.

According to the present invention, desirably, each of the left and right end caps includes: coupling slots formed on the outer periphery of the side plate of the housing; and hooks formed on the underside of the supporter in such a manner as to be fitted to the coupling slots.

According to the present invention, desirably, each of the left and right end caps includes slots incised on the left and right sides of each hook to induce the elastic deformation of each hook at the time when the hooks of the supporter are coupled to the coupling slots of the housing.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a reflection cap for a lamp according to the present invention;

FIG. 2 is an exploded perspective view showing the reflection cap for a lamp according to the present invention;

FIG. 3 is a sectional view showing a left end cap portion in the reflection cap for a lamp according to the present invention;

FIG. 4 is a side view showing the reflection cap for a lamp according to the present invention;

FIG. 5 is a sectional view showing the light reflection and irradiation by a fluorescent lamp in the reflection cap for a lamp according to the present invention; and

FIG. 6 is a perspective view showing the connection state where the fluorescent lamp in the reflection cap for a lamp according to the present invention is connected to a socket.

### DETAILED DESCRIPTION OF THE PREFERRED EMBODIMENT

Hereinafter, an explanation on a reflection cap for a lamp according to the present invention will be in detail given with reference to the attached drawing.

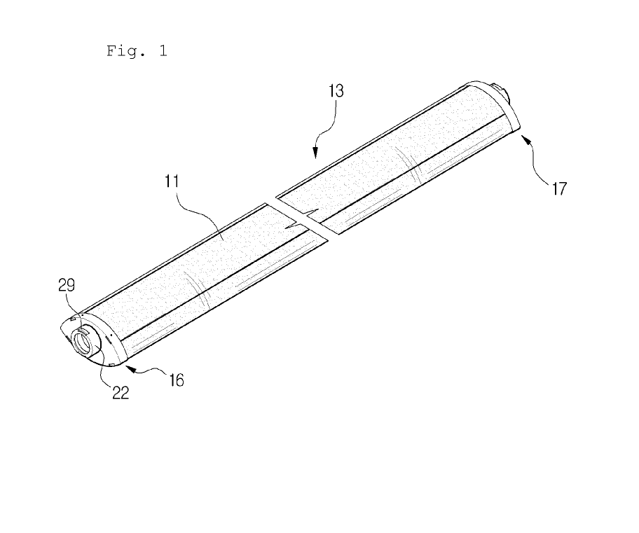

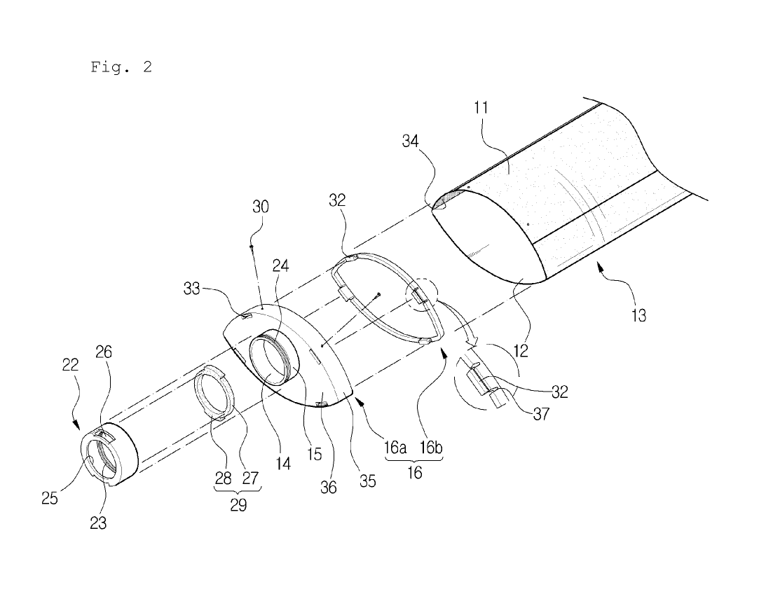

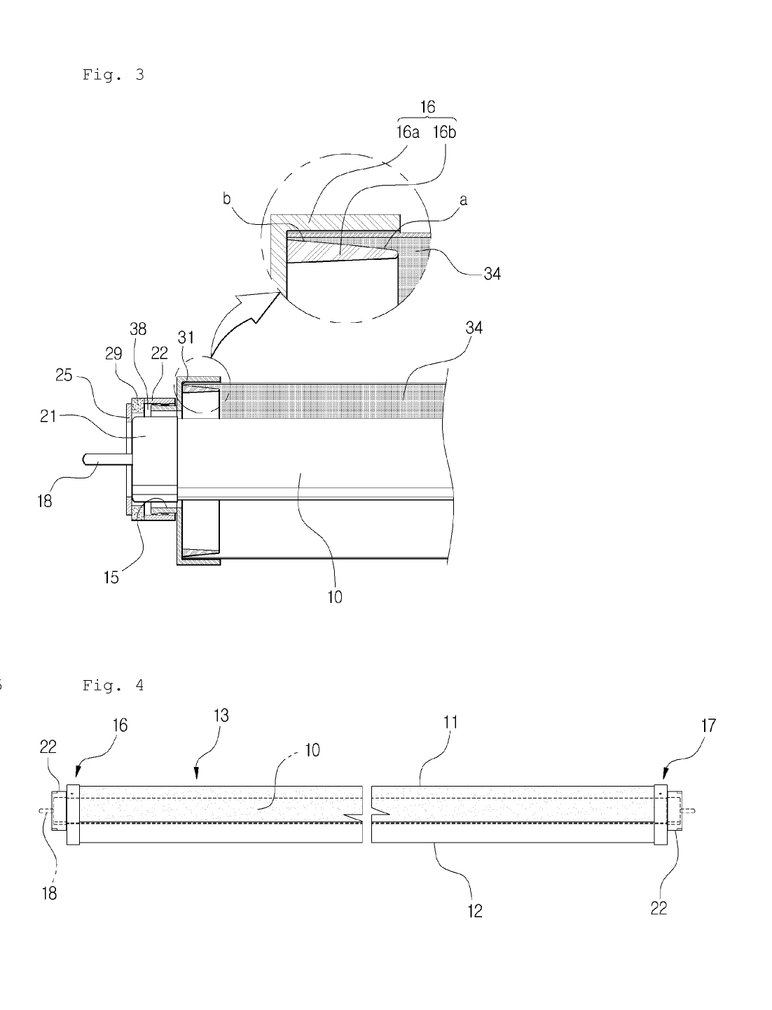

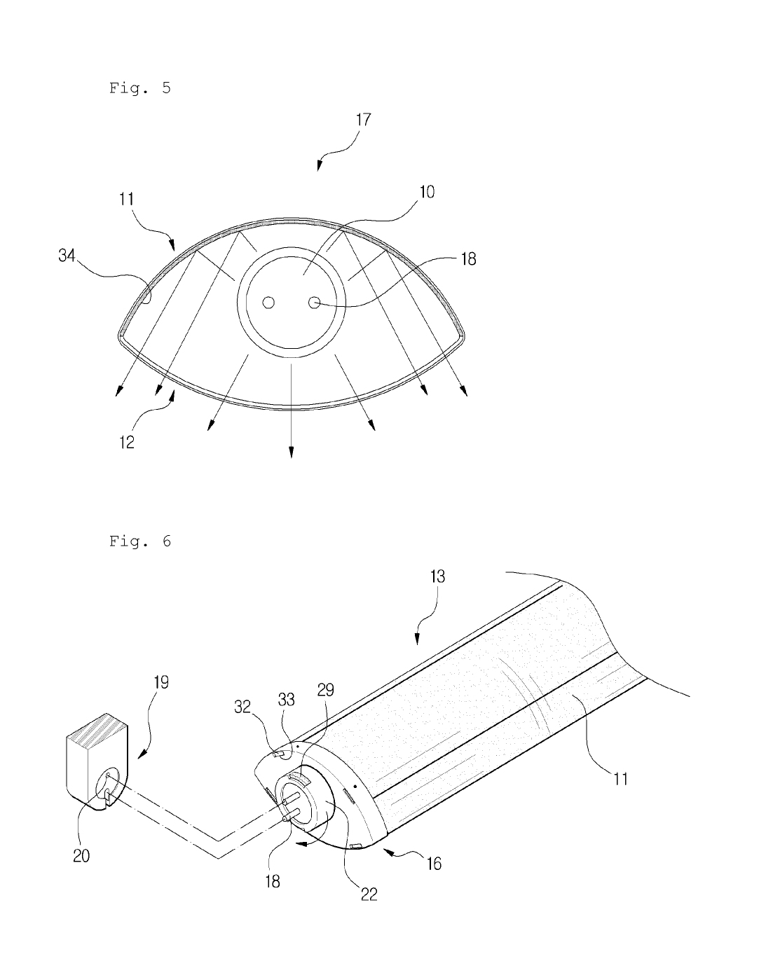

As shown in FIGS. 1 to 6, a reflection cap for a lamp according to the present invention includes: a body 13 open on both ends thereof and having a reflection plate 11 disposed on the upper portion thereof in such a manner as to reflect the light emitted by a fluorescent lamp 10 (which includes for example a bar-like lamp) housed therein and a transparent plate 12 (which is made of for example a PET material) disposed on the lower portion thereof in such a manner as to be connected to both ends of the underside portion of the reflection plate 11 (alternatively, the transparent plate 12 is partially overlapped to the reflection plate 11 and connected thereto by means of double coated tape) and to transmit the light emitted by the fluorescent lamp 10 therethrough; left and right end caps 16 and 17 detachably fixed to both ends of the body 13 and each having a boss 15 protrudedly formed on the outer surface thereof, the boss 15 having a through-hole 14 formed thereon in such a manner as to fittingly insert the fluorescent lamp 10 thereinto, and the left and right end caps 16 and 17 being made through injection molding; and a fluorescent lamp fixing member 22 rotatably coupled to the boss 15 and adapted to hold and rotate a fluorescent lamp finishing portion 21 clockwisely or counter-clockwisely so as to connect connection terminals 18 of the fluorescent lamp 10 fitted to the through-hole 14 to connection terminals 20 of a socket 19 (which supplies commercial power to the fluorescent lamp 10), the fluorescent lamp fixing member 22 being made through injection molding.

The fluorescent lamp fixing member 22 has a female screw portion 23 formed along the inner periphery thereof, and the boss 15 has a corresponding male screw portion 24 to the female screw portion 23 formed on the outer periphery thereof, so that the fluorescent lamp fixing member 22 can be detachably screw-coupled to the boss 15. If a strong force is applied to couple or separate the fluorescent lamp fixing member 22 to or from the boss 15, accordingly, the bosses 15 of the left and right end caps 16 and 17 may be broken. Through the screw-coupling of the fluorescent lamp fixing member 22 and the boss 15, however, the breakage of the boss 15 can be prevented.

The fluorescent lamp fixing member 22 has a locking step 25 formed on the inside bottom periphery thereof, through-holes 26 formed radially on the lower periphery thereof in such a manner as to face each other, and a packing 29 having a ring 27 seated on the locking step 25 and pressurizing portions 28 protrudedly formed from the outer peripheral surface of the ring 27 in such a manner as to be fitted to the through-holes 25, so that as the pressurizing portions 28 are pressed in the radial direction of the fluorescent lamp fixing member 22, the fluorescent lamp fixing member 22 can hold the fluorescent lamp finishing portion 21.

The packing 29 is made of a silicone material or rubber material having durability in temperature. Accordingly, if the fluorescent lamp finishing portion 21 is held by means of the pressurizing portions 28 of the packing 29 to exchange the fluorescent lamp 10 flickering because of the completion of the lifetime, the high temperature heat generated from the fluorescent lamp finishing portion 21 is not transmitted to a worker (which means a person who exchanges the fluorescent lamp 10, thereby ensuring the safety of the worker.

Next, the structures of the left and right end caps 16 and 17 will be explained, and for the brevity of description, an explanation on the structure of the left end cap 16 will be given below.

The left end cap 16 includes: a housing 16a having a side plate 36 having the boss 15 disposed on the outer surface thereof and a support plate 35 formed on the inner periphery thereof to a shape of a streamline in such a manner as to support the outer surfaces of the end portions of the reflection plate 11 and the transparent plate 12 of the body 13; and a streamline-shaped supporter 16b fixed to the support plate 35 in such a manner as to be spaced apart from the support plate 35 to support the inner surfaces of the end portions of the reflection plate 11 and the transparent plate 12 of the body 13, so that each end portion of the body 13 of the reflection cap is fixedly fitted to a streamline-shaped coupling slot 31 formed by the support plate 35 of the housing 16a and the supporter 16b.

The body 13, which is composed of the reflection plate 11 and the transparent plate 12, has a streamlined cross section. Accordingly, the irradiation angle of light emitted by the fluorescent lamp 10 can be enlarged by means of the arch-shaped transparent plate 12, thereby enhancing the illumination.

So as to enhance the reflection rate of light emitted by the fluorescent lamp 10 and thus to improve the illumination, the reflection plate 11 includes a reflection layer 34 formed on the inner surface thereof, the reflection layer 34 being formed of a layer of silver coated with silver or a silver reflection film.

The left end cap 16 includes: coupling slots 33 formed on the outer periphery of the side plate 36 of the housing 16a; and hooks 32 formed on the underside surface of the supporter 16b in such a manner as to be fitted to the coupling slots 33.

Further, the left end cap 16 includes slots 37 incised on the left and right sides of each hook 32 to induce the elastic deformation of each hook 32 at the time when the hooks 32 of the supporter 16b are coupled to the coupling slots 33 of the housing 16a.

If the hooks 32 are fitted to the coupling slots 33 to fix the supporter 16b to the housing 16a, they are elastically deformed by means of the slots 37, thereby allowing the supporter 16b to be easily coupled to the housing 16a. In case where the supporter 16b is molded to a relatively small thickness, accordingly, the formation of the slots 37 prevents the hooks 32 from being broken at the time when the supporter 16b is fitted to the housing 16a.

The supporter 16 further includes: a first slant surface a formed on the upper portion of the outer peripheral surface thereof in such a manner as to guide the sliding of the body 13 if each end of the body 13 is fitted to the streamlined coupling slot 31; and a second slant surface b formed on the lower portion of the outer peripheral surface thereof to a slower inclination degree than that of the first slant surface a in such a manner as to compressingly support each end portion of the body 13 fitted to the streamlined coupling slot 31.

If each end of the body 13 of the reflection cap is fitted to the streamlined coupling slot 31 of each of the left and right end caps 16 and 17 so as to be fixed to each of the left and right end caps 16 and 17, the inner surface of the end portion side of the reflection plate 11 of the body 13 is brought into close contact with the first slant surface a of the supporter 16b and slid toward the inside of the coupling slot 31. At this time, the end portion of the body 13 is slid along the second slant surface b of the supporter 16b having the slower inclination degree than the first slant surface a and fitted to the inside of the coupling slot 31, thereby being compressedly fixed by means of the support plate 35 and the supporter 16b of the housing 16a.

A reference numeral 30 not explained yet denotes fastening members adapted to fix the left and right end caps 16 and 17 to the body 13 of the reflection cap.

Hereinafter, an example of the use of the reflection cap for a lamp according to the present invention will be explained in detail with reference to the attached drawings.

As shown in FIGS. 1 to 6, the reflection cap (means the body 13 composed of the transparent plate 12 and the reflection plate 11) is applied to the fluorescent lamp 10 installed on the ceiling of a building in industrial fields such as sewing plants and the like, thereby enhancing the illumination produced by the fluorescent lamp 10.

After the fluorescent lamp 10 is housed in the body 13 of the reflection cap, both ends of the body 13 are fitted to the streamlined coupling slots 31 formed on the inside of the left and right end caps 16 and 17. At this time, both ends of the fluorescent lamp 10 are insertedly fitted to the through-holes 14 of the bosses 15 formed on the outer surfaces of the left and right end caps 16 and 17. Next, the body 13 and the left and right end caps 16 and 17 fitted to both ends of the body 13 are fixed to each other by means of the fastening members 30 (for example, screws).

After that, the fluorescent lamp fixing member 22 having the corresponding female screw portion 23 to the male screw portion 24 formed on the outer periphery of the boss 15 is screw-coupled to the male screw portion 24 of the boss 15. At this time, if the male screw portion 24 of the boss 15 is escaped from the female screw portion 23 of the fluorescent lamp fixing member 22 and located in a space portion 38 of the fluorescent lamp fixing member 22, the fluorescent lamp fixing member 22 becomes freely rotated with respect to the boss 15.

If the pressurizing portions 28 of the packing 29 coupled to the through-holes 26 of the fluorescent lamp fixing member 22 are pressed in the radial direction of the fluorescent lamp fixing member 22, the fluorescent lamp finishing portion 21 can be held by means of the packing 29. Accordingly, if the fluorescent lamp finishing portion 21 is held and rotated clockwisely or counter-clockwisely, the connection terminals 18 formed on the fluorescent lamp finishing portion 21 are conductively connected to the connection terminals 20 of the socket 19.

As the lighting of the fluorescent lamp 10 is conducted by the commercial power supplied from the socket 19, the light emitted from the fluorescent lamp 10 is transmitted to the transparent plate 12 and irradiated to the floor side of the building.

The light emitted upward from the fluorescent lamp 10 is reflected by the reflection plate 11 of the body 13 of the reflection cap and inducedly irradiated through the transparent plate 12 to the floor side of the building.

Through the arch-shaped transparent plate 12 of the streamlined body 13 of the reflection cap, the irradiation angle of light of the fluorescent lamp 10 can be enlarged. At this time, the reflection rate of the light can be enhanced by means of the reflection layer 34 formed of the silver reflection film attached to the inner surface of the reflection plate 11.

As the illumination produced by the fluorescent lamp 10 is enhanced, accordingly, a quantity of energy consumed by the use of the fluorescent lamp 10 can be reduced.

On the other hand, the left and right end caps 16 and 17 are fixed to the body 13 open from both sides, and the fluorescent lamp fixing member 22 is fitted to the boss 15 of each end cap. As a result, the interior of the body 13 into which the fluorescent lamp 10 is housed is cut off from the exterior thereof and completely closed.

Even if the installation place of the fluorescent lamp 10 corresponds to an environment like a sewing plant where a lot of dust is generated during working, the foreign matters like fiber dust may not enter the body 13 of the reflection cap, thereby preventing the decrement of the illumination of the fluorescent lamp 10 caused by the accumulation of the dust on the surface of the reflection plate 11 or the fluorescent lamp 10.

Accordingly, there is no need to clean the fluorescent lamp 10 or to remove the foreign matters through the separation of the fluorescent lamp 10 from the body 13, thereby providing the easiness of the maintenance thereof. Further, even in case where the fluorescent lamp 10 is broken inside the body 13 of the reflection cap, the glass pieces of the fluorescent lamp 10 are not escaped from the interior of the body 12, thereby protecting workers who are in the working place from the glass pieces of the fluorescent lamp 10.

On the other hand, if the lifetime of the fluorescent lamp 10 housed in the body 13 of the reflection cap is passed or the fluorescent lamp 10 is broken, the fluorescent lamp 10 can be easily exchanged. That is, the pressurizing portions 28 of the packing 29 coupled to the fluorescent lamp fixing member 22 are pressed to hold the fluorescent lamp finishing portion 21 and to rotate the fluorescent lamp 10 clockwisely and counter-clockwisely, so that the connection terminals 28 of the fluorescent lamp 10 can be separated from the connection terminals 20 of the socket 19. That is, the body 13 of the reflection cap in which the fluorescent lamp 10 is housed can be separated from the socket 19.

The locking states of the fastening members 30 fixing the left and right end caps 16 and 17 to the body 13 of the reflection cap are released to allow the left and right end caps 16 and 17 to be separated from the body 13 of the reflection cap. At this time, any one of the left and right end caps 16 and 17 can be separated from the body 13 of the reflection cap.

Accordingly, the fluorescent lamp 10 whose lifetime is passed or damaged is detached from the body 13 of the reflection cap and then exchanged. At this time, the body 13 of the reflection cap can be easily separated from and coupled to the streamlined coupling slot 31 formed on the left and right end caps 16 and 17 having durability through injection molding. As a result, the operation of exchanging the fluorescent lamp 10 into the body 13 of the reflection cap is easily conducted, and the exchanging time is also reduced, thereby providing many conveniences and reliability to users.

As described above, the reflection cap for a lamp according to the present invention has the following advantages.

First, the transparent plate and the reflection plate, which constitute the body of the reflection cap encompassing the fluorescent lamp, take the streamlined shape, thereby allowing the irradiation angle of light emitted from the fluorescent lamp to be enlarged to enhance the reflection rate of the light and further to improve the illumination, so that there is no need to install specific lamps in working environments such as sewing plants, electronic appliance assembling lines and the like wherein high illumination is required for long hours, thereby reducing a quantity of energy consumed thereby.

Second, the reflection cap of this invention is simple in configuration to reduce the manufacturing cost, the fluorescent lamp is easily exchanged, and the reflection cap is easily assembled and installed, thereby providing many conveniences and practicability.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A reflection cap for a lamp comprising:
a body open on both ends thereof and having a reflection plate disposed on the upper portion thereof in such a manner as to reflect the light emitted by a fluorescent lamp housed therein and a transparent plate disposed on the lower portion thereof in such a manner as to be connected to both ends of the underside portion of the reflection plate and to transmit the light emitted by the fluorescent lamp therethrough;
left and right end caps detachably fixed to both ends of the body and each having a boss protrudedly formed on the outer surface thereof, the boss having a through-hole formed thereon in such a manner as to fittingly insert the fluorescent lamp thereinto; and
a fluorescent lamp fixing member rotatably coupled to the boss and adapted to hold and rotate a fluorescent lamp finishing portion clockwisely or counter-clockwisely so as to connect connection terminals of the fluorescent lamp fitted to the through-hole to connection terminals of a socket.

2. The reflection cap for a lamp according to claim 1, wherein the fluorescent lamp fixing member has a female screw portion formed along the inner periphery thereof, and the boss has a corresponding male screw portion to the female screw portion formed on the outer periphery thereof, so that the fluorescent lamp fixing member is detachably screw-coupled to the boss.

3. The reflection cap for a lamp according to claim 1, wherein the fluorescent lamp fixing member comprises:
a locking step formed on the inside bottom periphery thereof;
through-holes formed radially on the lower periphery thereof in such a manner as to face each other; and
a packing having a ring seated on the locking step and pressurizing portions protrudedly formed from the outer peripheral surface of the ring in such a manner as to be fitted to the through-holes, so that as the pressurizing portions are pressed in the radial direction of the fluorescent lamp fixing member, the fluorescent lamp fixing member holds the fluorescent lamp finishing portion.

4. The reflection cap for a lamp according to claim 3, wherein the packing is made of a silicone material or rubber material.

5. The reflection cap for a lamp according to claim 1, wherein each of the left and right end caps comprises:
a housing having a side plate having the boss disposed on the outer surface thereof and a support plate formed on the inner periphery thereof to a shape of a streamline in such a manner as to support the outer surfaces of the end portions of the reflection plate and the transparent plate of the body; and
a streamline-shaped supporter fixed to the support plate in such a manner as to be spaced apart from the support plate to support the inner surfaces of the end portions of the reflection plate and the transparent plate of the body, so that each end portion of the body of the reflection cap is fixedly fitted to a streamline-shaped coupling slot formed by the support plate of the housing and the supporter.

6. The reflection cap for a lamp according to claim 1, wherein the body has a streamlined cross section.

7. The reflection cap for a lamp according to claim 1, wherein the reflection plate includes a reflection layer formed on the inner surface thereof to enhance the illumination of the fluorescent lamp, the reflection layer being formed of a layer of silver coated with silver or a silver reflection film.

8. The reflection cap for a lamp according to claim 1, wherein the transparent plate is made of any one of a PET material, PC material, acrylic material, and PMMA material.

9. The reflection cap for a lamp according to claim 5, wherein the supporter comprises:
a first slant surface formed on the upper portion of the outer peripheral surface thereof in such a manner as to guide the sliding of the body if each end of the body is fitted to the streamlined coupling slot; and
a second slant surface formed on the lower portion of the outer peripheral surface thereof to a slower inclination degree than that of the first slant surface in such a manner as to compressingly support each end portion of the body fitted to the streamlined coupling slot.

10. The reflection cap for a lamp according to claim 5, wherein each of the left and right end caps comprises:
coupling slots formed on the outer periphery of the side plate of the housing; and
hooks formed on the underside of the supporter in such a manner as to be fitted to the coupling slots.

11. The reflection cap for a lamp according to claim 10, wherein each of the left and right end caps includes slots incised on the left and right sides of each hook to induce the elastic deformation of each hook at the time when the hooks of the supporter are coupled to the coupling slots of the housing.
